(19) United States
(12) Patent Application Publication
(10) Pub. No.: US 2016/0090310 A1
(43) Pub. Date: Mar. 31, 2016

(54) LOW-CHLORIDE ELECTROLYTE

(71) Applicant: LANXESS DEUTSCHLAND GMBH, Köln (DE)

(72) Inventors: Thomas LINDER, Cologne (DE); Matthias BOLL, Cologne (DE); Eberhard KUCKERT, Leverkusen (DE)

(21) Appl. No.: 14/782,701

(22) PCT Filed: Apr. 10, 2014
(86) PCT No.: PCT/EP2014/057269

§ 371 Date: Oct. 6, 2015

(30) Foreign Application Priority Data
Apr. 12, 2013 (EP) 13163517.9

(51) Int. Cl. C01D 15/00; H01M 10/052; H01M 10/0568

(52) U.S. Cl. CPC C01D 15/005; H01M 10/0568; H01M 10/052; C01P 2006/80; C01P 2006/40; H01M 2300/0017

(57) ABSTRACT

The present invention relates to a method for preparing low-chloride lithium hexafluorophosphate starting from lithium fluoride and phosphorus pentafluoride and use thereof in an electrolyte.

The present invention relates to a method for preparing low-chloride lithium hexafluorophosphate starting from lithium fluoride and phosphorus pentafluoride and use thereof in an electrolyte.

The global spread of portable electronic devices, for example laptop and palmtop computers, mobile phones or video cameras, and hence also the demand for lightweight and high-performance batteries and accumulators, has increased dramatically in the last few years. This will be augmented in the future by the equipping of electrical vehicles with accumulators and batteries of this kind.

Lithium hexafluorophosphate (LiPF₆) has gained high industrial significance particularly as a conductive salt in the production of high-performance accumulators. In order to assure the ability of such accumulators to function and the lifetime and hence the quality thereof, it is particularly important that the lithium compounds used contain minimal proportions of chloride. Chloride ions are held responsible for cell short-circuits due to corrosion.

The prior art discloses numerous processes for preparing lithium hexafluorophosphate. For example, one option is preparation according to the following reaction scheme:

Stage 1 PCl₃+3 HF→PF₃+3 HCl
Stage 2 PF₃+Cl₁→PCl₂F₃
Stage 3 PCl₂F₃+2 HF→PF₅+2 HCl
Stage 4 PF₅+LiF→LiPF₆

DE19712988A1 describes a process operated batchwise starting from phosphorus trichloride (PCl₃). This involved initially charging an experimental reactor with lithium fluoride, and baking it out at 150° C. under argon. Phosphorus trichloride was charged in a laboratory autoclave, then hydrogen fluoride and then elemental chlorine were metered in. The resulting gas mixture of hydrogen chloride and phosphorus pentafluoride was passed over the lithium fluoride in the experimental reactor to obtain lithium hexafluorophosphate.

JP11171518 A2 describes a process for preparing lithium hexafluorophosphate which proceeds from phosphorus trichloride and hydrogen fluoride via phosphorus trifluoride, wherein the latter is first reacted with elemental chlorine to give phosphorus dichloride trifluoride, the latter is in turn reacted with hydrogen fluoride to give phosphorus pentafluoride, and the latter is finally reacted with lithium fluoride to give lithium hexafluorophosphate in an organic solvent. Organic solvents used are diethyl ether and dimethyl carbonate. JP 11171518 A2 does point out the formation of toxic HCl gas, but there are no pointers in the prior art to the chloride content in the lithium hexafluorophosphate obtained. However, the process regime suggests a significant chloride content

U.S. Pat. No. 3,594,402 describes the preparation of improved lithium hexafluorophosphate from tetraacetontrilolithium hexafluorophosphate by reaction of lithium fluoride and phosphorus pentafluoride with excess acetonitrile. The excess acetonitrile is removed under vacuum.

A method for preparing solutions of lithium hexafluorophosphate is also known from U.S. Pat. No. 5,378,445, comprising the reaction of a lithium salt, under basic conditions, with a salt selected from sodium, potassium, ammonium or an organoammonium hexafluorophosphate salt, in a low-boiling, aprotic organic solvent. In this case, a solution is obtained comprising lithium hexafluorophosphate and a precipitated sodium, potassium, ammonium or organoammonium salt comprising the anion of the lithium salt reaction partner.

DE2026110 describes a method for preparing hexafluorophosphate salts of tetraacetonitrilolithium, characterized in that a stoichiometric excess of acetonitrile is reacted with hexafluorophosphate salts of lithium at a temperature of about −40° C. to about 80° C. The excess acetonitrile is removed under reduced pressure.

In J. Liu, X. Li, Z. Wang, H. Guo, W. Peng, Y. Zhang, Q. Hu, Trans. Nonferrous Met. Soc. China 2010, 20, 344-348, a preparation method for lithium hexafluorophosphate is described. Phosphorus pentafluoride is firstly prepared from calcium fluoride and phosphorus pentoxide. Lithium hexafluorophosphate was synthesized in an acetonitrile solution by reacting lithium fluoride with phosphorus pentafluoride at room temperature. The purity of the lithium hexafluorophosphate prepared was 99.98%.

The prior art shows that it is technically very complex to achieve high purities for lithium hexafluorophosphate, and especially to keep the chloride content low. The processes known to date for preparing lithium hexafluorophosphate are consequently unable to fulfil every purity requirement.

Accordingly, an object of the present invention was to develop an efficient method for preparing low-chloride lithium hexafluorophosphate.

The solution to the problem and the subject-matter of the present invention is a method for preparing low-chloride lithium hexafluorophosphate comprising at least the steps of:
a) bringing lithium fluoride in a first organic solvent comprising a nitrile into contact with a gas comprising phosphorus pentafluoride and hydrogen chloride, wherein a reaction mixture is obtained comprising lithium hexafluorophosphate, a first organic solvent comprising a nitrile and hydrogen chloride,
b) bringing the reaction mixture formed according to a) into contact with a further organic solvent, which is different from the first organic solvent, whereupon lithium hexafluorophosphate precipitates out and c) separating the precipitated lithium hexafluorophosphate,

It should be noted at this point that the scope of the invention includes any and all possible combinations of the components, ranges of values and/or process parameters mentioned above and cited hereinafter, in general terms or within areas of preference.

In step a), lithium fluoride in a first organic solvent is brought into contact with a gas comprising phosphorus pentafluoride and hydrogen chloride, wherein a reaction mixture is obtained comprising lithium hexafluorophosphate, a first organic solvent and hydrogen chloride.

The lithium fluoride used in step a) has, for example, a purity level of 98.0000 to 99.9999% by weight, preferably 99.0000 to 99.9999% by weight, more preferably 99.9000 to 99.9995% by weight, especially preferably 99.9500 to 99.9995% by weight and very especially preferably 99.9700 to 99.9995% by weight, based on anhydrous product.

The lithium fluoride used additionally preferably has extraneous ions in:
1) a content of 0.1 to 250 ppm, preferably 0.1 to 75 ppm, more preferably 0.1 to 50 ppm and especially preferably 0.5 to 10 ppm and very especially preferably 0.5 to 5 ppm of sodium in ionic form,
2) a content of 0.01 to 200 ppm, preferably 0.01 to 10 ppm, more preferably 0.5 to 5 ppm and especially preferably 0.1 to 1 ppm of potassium in ionic form.
3) a content of 0.05 to 500 ppm, preferably 0.05 to 300 ppm, more preferably 0.1 to 250 ppm and especially preferably 0.5 to 100 ppm of calcium in ionic form and/or
4) a content of 0.05 to 300 ppm, preferably 0.1 to 250 ppm and especially preferably 0.5 to 50 ppm of magnesium in ionic form.

The lithium fluoride used additionally has, for example, extraneous ions in
i) a content of 0.1 to 1000 ppm, preferably 0.1 to 100 ppm and especially preferably 0.5 to 10 ppm of sulfate and/or
i) a content of 0.1 to 1000 ppm, preferably 0.5 to 500 ppm, of chloride,
   likewise based on the anhydrous product, where the sum total of lithium fluoride and the aforementioned extraneous ions does not exceed 1 000 000 ppm, based on the total weight of the technical grade lithium carbonate based on the anhydrous product.

In one embodiment, the lithium fluoride contains a content of extraneous metal ions totaling 1000 ppm or less, preferably 300 ppm or less, especially preferably 20 ppm or less and very especially preferably 10 ppm or less.

The ppm figures given here, unless explicitly stated otherwise, are generally based on parts by weight; the contents of the cations and anions mentioned are determined by ion chromatography, unless stated otherwise according to the details in the experimental section.

The lithium fluoride having the aforementioned specifications can be obtained, for example, by a process comprising at least the following steps:
i) providing an aqueous medium comprising dissolved lithium carbonate
ii) reacting the aqueous medium provided in a) with gaseous hydrogen fluoride to give an aqueous suspension of solid lithium fluoride
ii) separating the solid lithium fluoride from the aqueous suspension
iv) drying the separated lithium fluoride.

In step i), an aqueous solution comprising lithium carbonate is provided.

The term “aqueous medium comprising dissolved lithium carbonate” here is understood to mean a liquid medium which
i) contains dissolved lithium carbonate, preferably in an amount of at least 2.0 g/l, especially preferably 5.0 g/l up to the maximum solubility in the aqueous medium at the selected temperature, very especially preferably 7.0 g/l up to the maximum solubility in the aqueous medium at the selected temperature. In particular, the lithium carbonate content is 7.2 to 15.4 g/l. The person skilled in the art is aware that the solubility of lithium carbonate is 15.4 g/l in pure water at 0° C., 13.3 g/l at 20° C., 10.1 g/l at 60° C. and 7.2 g/l at 1000° C., and consequently certain concentrations can be obtained only at particular temperatures
ii) contains a proportion by weight of at least 50% water, preferably 80% by weight, especially preferably at least 90% by weight, based on the total weight of the liquid medium, and
iii) is preferably also solids-free or has a solids content of more than 0.0 up to 0.5% by weight, is preferably solids-free or has a solids content of more than 0.0 up to 0.1% by weight, is especially preferably solids-free or has a solids content of more than 0.0 up to 0.005% by weight, and is especially preferably solids-free,
   where the sum total of components i), ii) and preferably iii) is not more than 100% by weight, preferably 98 to 100% by weight and especially preferably 99 to 100% by weight, based on the total weight of the aqueous medium comprising dissolved lithium carbonate.

The aqueous medium comprising dissolved lithium carbonate may comprise, in a further embodiment of the invention, as a further component,
iv) at least one water-miscible organic solvent. Suitable water-miscible organic solvents are, for example, mono- or polyhydric alcohols such as methanol, ethanol, n-propanol, isopropanol, n-butanol, ethylene glycol, ethylene glycol monomethyl ether, ethylene glycol monoethyl ether, propylene glycol, propane-1,3-diol or glycerol, ketones such as acetone or ethyl methyl ketone.

If the aqueous medium comprising dissolved lithium carbonate comprises at least one water-miscible organic solvent, the proportion thereof may, for example, be more than 0.0% by weight to 20% by weight, preferably 2 to 10% by weight, where the sum total in each case of components i), ii), iii) and iv) is not more than 100% by weight, preferably 95 to 100% by weight and especially preferably 98 to 100% by weight, based on the total weight of the aqueous medium comprising dissolved lithium carbonate.

Preferably, however, the aqueous medium comprising dissolved lithium carbonate is free of water-miscible organic solvents.

The aqueous medium comprising dissolved lithium carbonate may contain, as a further component,
v) a complexing agent, preferably in an amount of 0.001 to 1% by weight, preferably 0.005 to 0.2% by weight, based on the total weight of the aqueous medium comprising dissolved lithium carbonate.

Complexing agents are preferably those whose complexes with calcium ions and magnesium ions form complexes which have a solubility of more than 0.02 mol/I at a pH of 8 and 20° C.

Examples of suitable complexing agents are ethylenediaminetetraacetic acid (EDTA) and the alkali metal or ammonium salts thereof, preference being given to ethylenediaminetetraacetic acid.

In one embodiment, however, the aqueous medium comprising dissolved lithium carbonate is free of complexing agents.

The procedure for provision of the aqueous solution comprising lithium carbonate is preferably to contact solid lithium carbonate with an aqueous medium which is free of lithium carbonate or low in lithium carbonate, such that the solid lithium carbonate at least partly goes into solution. An aqueous medium low in lithium carbonate is understood to mean an aqueous medium which has a lithium carbonate content of up to 1.0 g/l, preferably up to 0.5 g/l, but is not free of lithium carbonate.

The aqueous medium used for the provision fulfils the conditions mentioned above under ii) and iii), and optionally includes components iv) and v).

In the simplest case, the aqueous medium is water, preferably water having a specific electrical resistivity of 5 MΩ·cm at 25° C. or more.

In a preferred embodiment, steps i) to iv) are repeated once or more than once, repeated once or more than once. In this case, in the repetition for provision of the aqueous medium comprising dissolved lithium carbonate, the aqueous medium free of lithium carbonate or low in lithium carbonate used is the aqueous medium which is obtained in a preceding step iii) in the separation of solid lithium fluoride from the aqueous suspension of lithium fluoride. In this case, the aqueous medium free of lithium carbonate or low in lithium carbonate comprises dissolved lithium fluoride, typically up to the saturation limit at the particular temperature.

In one embodiment, the aqueous medium free of or low in lithium carbonate can be contacted with the solid lithium carbonate in a stirred reactor, a flow reactor or any other apparatus known to those skilled in the art for the contacting of liquid substances with solid substances. Preferably, for the purpose of a short residence time and the attainment of a lithium carbonate concentration very close to the saturation point in the aqueous medium used, an excess of lithium carbonate is used, i.e. a sufficient amount that full dissolution of the solid lithium carbonate is not possible. In order to limit the solids content in accordance with ii) in this case, there follows a filtration, sedimentation, centrifugation or any other process which is known to those sidled in the art for the separation of solids out of or from liquid, preference being given to filtration.

If process steps i) to iii) are performed repeatedly and/or continuously, filtration through a crossflow filter is preferred.

The contacting temperature may be, for example, from the freezing point to the boiling point of the aqueous medium used, preferably 0 to 100° C., especially preferably 10 to 60° C. and especially preferably 10 to 35° C., particularly 16 to 24° C.

The contacting pressure may, for example, be 100 hPa to 2 MPa, 900 hPa to 1200 hPa, especially ambient pressure is particularly preferred.

In the context of the invention, technical grade lithium carbonate is understood to mean lithium carbonate having a purity level of 95.0 to 99.9% by weight, preferably 98.0 to 99.8% by weight and especially preferably 98.5 to 99.8% by weight, based on anhydrous product.

Preferably, the technical grade lithium carbonate further comprises extraneous ions, i.e. Ions that are not lithium or carbonate ions, in
1) a content of 200 to 5000 ppm, preferably 300 to 2000 ppm and especially preferably 500 to 1200 ppm of sodium in ionic form and/or
2) a content of 5 to 1000 ppm, preferably 10 to 600 ppm, of potassium in Ionic form and/or
3) a content of 50 to 1000 ppm, preferably 100 to 500 ppm and especially preferably 100 to 400 ppm of calcium in ionic form and/or
4) a content of 20 to 500 ppm, preferably 20 to 200 ppm and especially preferably 50 to 100 ppm of magnesium in Ionic form.
5) a content of 50 to 1000 ppm, preferably 100 to 800 ppm, of sulfate and/or
6) a content of 10 to 1000 ppm, preferably 100 to 500 ppm, of chloride, likewise based on the anhydrous product.

It is generally the case that the sum total of lithium carbonate and the aforementioned extraneous ions 1) to 4) and optionally i) and ii) does not exceed 1 000 000 ppm, based on the total weight of the technical grade lithium carbonate based on the anhydrous product.

In a further embodiment, the technical grade lithium carbonate has a purity of 98.5 to 99.5% by weight and a content of 500 to 2000 ppm of extraneous metal ions, i.e. sodium, potassium, magnesium and calcium.

In a further embodiment, the technical grade lithium carbonate preferably additionally has a content of 100 to 800 ppm of extraneous anions, i.e. sulfate or chloride, based on the anhydrous product.

The ppm figures given here, unless explicitly stated otherwise, are generally based on parts by weight; the contents of the cations and anions mentioned are determined by ion chromatography, unless stated otherwise according to the details in the experimental section.

In one embodiment of the process according to the invention, the provision of the aqueous medium comprising lithium carbonate and the contacting of an aqueous medium free of or low in lithium carbonate are effected batchwise or continuously with solid lithium carbonate, preference being given to continuous performance.

The aqueous medium comprising dissolved lithium carbonate provided in step i) typically has a pH of 8.5 to 12.0, preferably of 9.0 to 11.5, measured or calculated at 20° C. and 1013 hPa.

Before the aqueous medium comprising dissolved lithium carbonate provided in step i) is used in step iib), it can be passed through an ion exchanger, in order to at least partly remove calcium and magnesium ions in particular. For this purpose, it is possible to use, for example, weakly or else strongly acidic cation exchangers. For use in the process according to the invention, the ion exchangers can be used in devices such as flow columns, for example, filled with the above-described cation exchangers, for example in the form of powders, beads or granules.

Particularly suitable ion exchangers are those comprising copolymers of at least styrene and divinylbenzene, which additionally contain, for example, aminoalkylenephosphonic acid groups or iminodiacetic acid groups.

Ion exchangers of this kind are, for example, those of the Lewatit TM type, for example Lewatit TM OC 1060 (AMP type), Lewatit TM TP 208 (IDA type), Lewatit TM E 304/88, Lewatit TM S 108, Lewatit TP 207, Lewatit TM S 100; those of the Amberlite TM type, for example Amberlite TM IR 120, Amberlite TM IRA 743; those of the Dowex TM type, for example Dowex TM HCR; those of the Duolite type, for example Duolite TM C 20, Duolite TM C 467, Duolite TM FS 346; and those of the Imac TM type, for example Imac TM TMR, preference being given to Lewatit TM types.

Preference is given to using ion exchangers having minimum sodium levels. For this purpose, it is advantageous to rinse the ion exchanger prior to use thereof with the solution of a lithium salt, preferably an aqueous solution of lithium carbonate.

In one embodiment of the process according to the invention, no treatment with ion exchangers takes place.

In step ii), the aqueous medium comprising dissolved lithium carbonate provided in step i) is reacted with gaseous hydrogen fluoride to give an aqueous suspension of solid lithium fluoride.

The reaction can be effected, for example, by introducing or passing a gas stream comprising gaseous hydrogen fluoride into or over the aqueous medium comprising dissolved lithium carbonate, or by spraying or nebulizing the aqueous medium comprising dissolved lithium carbonate, or causing it to flow, into or through a gas comprising gaseous hydrogen fluoride.

Because of the very high solubility of gaseous hydrogen fluoride in aqueous media, preference is given to passing it over, spraying it, nebulizing it or passing it through, even further preference being given to passing it over.

The gas stream comprising gaseous hydrogen fluoride or gas comprising gaseous hydrogen fluoride used may either be gaseous hydrogen fluoride as such or a gas comprising gaseous hydrogen fluoride and an inert gas, an inert gas being understood to mean a gas which does not react with lithium fluoride under the customary reaction conditions. Examples are air, nitrogen, argon and other noble gases or carbon dioxide, preference being given to air and even more so to nitrogen.

The proportion of inert gas may vary as desired and is, for example, 0.01 to 99% by volume, preferably 1 to 20% by volume.

The reaction in step ii) forms lithium fluoride, which precipitates out because of the fact that it is more sparingly soluble in the aqueous medium than lithium carbonate, and consequently forms an aqueous suspension of solid lithium fluoride. The person skilled in the art is aware that lithium fluoride has a solubility of about 2.7 g/l at 20° C.

The reaction is preferably effected in such a way that the resulting aqueous suspension of solid lithium fluoride attains a pH of 3.5 to 8.0, preferably 4.0 to 7.5 and especially preferably 5.0 to 7.2. Carbon dioxide is released at these pH values. In order to enable the release thereof from the suspension, it is advantageous, for example, to stir the suspension or to pass it over static mixing elements.

The reaction temperature in step II) may, for example, be from the freezing point to the boiling point of the aqueous medium comprising dissolved lithium carbonate used, preferably 0 to 65° C., especially preferably 15 to 45° C. and especially preferably 15 to 35° C., particularly 16 to 24° C.

The reaction pressure in step ii) may, for example, be 100 hPa to 2 MPa, 900 hPa to 1200 hPa, especially ambient pressure is particularly preferred.

In step iii), the solid lithium fluoride is separated from the aqueous suspension.

The separation is effected, for example, by filtration, sedimentation, centrifugation or any other process which is known to those skilled in the art for the separation of solids out of or from liquids, preference being given to filtration.

If the filtrate is reused for step i) and process steps a) to c) are conducted repeatedly, a filtration through a crossflow filter is preferred.

The solid lithium fluoride thus obtained typically still has a residual moisture content of 1 to 40% by weight, preferably 5 to 30% by weight.

Before the lithium fluoride separated in step iii) is dried in step iv), it can be washed once or more than once with water or a medium comprising water and water-miscible organic solvents. Water is preferred. Water having an electrical resistivity of 15 MΩ·cm at 25° C. or more is particularly preferred. Water containing extraneous ions which adheres to the solid lithium fluoride from step iii) is very substantially removed as a result.

In step iv), the lithium fluoride is dried. The drying can be conducted in any apparatus known to those skilled in the art for drying. The drying is preferably effected by heating the lithium fluoride, preferably to 100 to 800° C., especially preferably 200 to 500° C.

The first organic solvent used, for example, can be a nitrile, a combination of nitriles or a combination of at least one nitrile with at least one organic solvent which is not a nitrile.

Examples of suitable nitriles are acetonitrile, propanitrile and benzonitrile. Especially preferably, acetonitrile is used.

By way of example, the molar ratio of nitriles used to the amount of lithium ions present in the reaction mixture from step a) is at least 1:1, preferably at least 10:1 and especially preferably at least 50:1 and very especially preferably at least 100:1.

Insofar as the first organic solvent, those used are those which are not a nitrile, organic solvents preferably used are those which are liquid at room temperature and have a boiling point of 300° C. or less at 1013 hPa and further comprise at least one oxygen atom or one nitrogen atom or both.

In this case, preferred organic solvents are those which do not have any protons having a pKa at 25° C., based on water or an aqueous comparative system, of less than 20. Organic solvents of this kind are also referred to in the literature as “aprotic” solvents.

Examples of such further organic solvents are esters, organic carbonates, ketones, ethers, acid amides or sulfones which are liquid at room temperature.

Examples of ethers are diethyl ether, diisopropyl ether, methyl tert-butyl ether, ethylene glycol dimethyl and diethyl ether, propane-1,3-diol dimethyl and diethyl ether, dioxane and tetrahydrofuran.

Examples of esters are methyl, ethyl and butyl acetate, or organic carbonates such as dimethyl carbonate (DMC), diethyl carbonate (DEC) or propylene carbonate (PC) or ethylene carbonate (EC).

One example of a sulfone is sulfolane.

Examples of ketones are acetone, methyl ethyl ketone and acetophenone.

Examples of acid amides are N,N-dimethylformamide, N,N-dimethylacetamide, N-methylformanilide, N-methylpyrrolidone or hexamethylphosphoramide.

The first organic solvent according to the invention may also comprise more than two of the organic solvents mentioned.

In an alternative embodiment, solid lithium fluoride is brought into contact with a first organic solvent.

In a further alternative embodiment, a first organic solvent is charged and solid lithium fluoride is added.

Here, the resulting suspension comprising lithium fluoride and a first organic solvent is brought into contact with gas comprising phosphorus pentafluoride and hydrogen chloride.

In an alternative embodiment, lithium fluoride and a first organic solvent are brought into contact under inert gas, preferably under argon.

The gas used in step a) comprising phosphorus pentafluoride and hydrogen chloride can be prepared in a manner known per se by a process comprising at least the following steps:
1) reacting phosphorus trichloride with hydrogen fluoride to give phosphorus trifluoride and hydrogen chloride
2) reacting phosphorus trifluoride with elemental chlorine to give phosphorus dichloride trifluoride
3) reacting phosphorus dichloride trifluoride with hydrogen fluoride to give phosphorus pentafluoride and hydrogen chloride.

The gas comprising phosphorus pentafluoride and hydrogen chloride used is therefore typically a gas mixture containing 5 to 41% by weight of phosphorus pentafluoride and 6 to 59% by weight of hydrogen chloride, preferably 20 to 41% by weight of phosphorus pentafluoride and 40 to 59% by weight of hydrogen chloride, especially preferably 33 to 41% by weight of phosphorus pentafluoride and 49 to 59% by weight of hydrogen chloride, where the proportion of phosphorus pentafluoride and hydrogen chloride is, for example, 11 to 100% by weight, preferably 90 to 100% by weight and more preferably 95 to 100% by weight.

The difference from 100% by weight, if any, may be chlorine, hydrogen fluoride or inert gases, an inert gas being understood here to mean a gas which does not react with phosphorus pentafluoride, hydrogen fluoride, hydrogen chloride or lithium fluoride under the customary reaction conditions. Examples are nitrogen, argon and other noble gases or carbon dioxide, preference being given to nitrogen.

The difference from 100% by weight, if any, may alternatively or additionally also be hydrogen fluoride.

Based on the overall process over stages 1) to 3), hydrogen fluoride is used, for example, in an amount of 4.5 to 8 mol, preferably 4.8 to 7.5 mol and especially preferably 4.8 to 6.0 mol of hydrogen fluoride per mole of phosphorus trichloride.

Typically, the gas comprising phosphorus pentafluoride and hydrogen chloride is therefore a gas mixture containing 5 to 41% by weight of phosphorus pentafluoride, 6 to 59% by weight of hydrogen chloride and 0 to 50% by weight of hydrogen fluoride, preferably 20 to 41% by weight of phosphorus pentafluoride, 40 to 59% by weight of hydrogen chloride and 0 to 40% by weight of hydrogen fluoride, especially preferably 33 to 41% by weight of phosphorus pentafluoride, 49 to 59% by weight of hydrogen chloride and 0 to 18% by weight of hydrogen fluoride, where the proportion of phosphorus pentafluoride, hydrogen chloride and hydrogen fluoride is, for example, 11 to 100% by weight, preferably 90 to 100% by weight and especially preferably 95 to 100% by weight.

In an alternative embodiment, the description gas comprising phosphorus pentafluoride and hydrogen chloride in step a) is understood to mean that the suspension comprising lithium fluoride and a first organic solvent is firstly brought into contact with hydrogen chloride gas and subsequently phosphorus pentafluoride gas.

In a further alternative embodiment, the description gas comprising phosphorus pentafluoride and hydrogen chloride in step a) is understood to mean that the suspension comprising lithium fluoride and a first organic solvent is firstly brought into contact with phosphorus pentafluoride gas and subsequently with hydrogen chloride gas.

The reaction pressure in step a) is, for example, 500 hPa to 5 MPa, preferably 900 hPa to 1 MPa and especially preferably 0.1 MPa to 0.5 MPa.

The reaction temperature in step a) is, for example, −60° C. to 150° C., preferably between 20 and 150° C. and very especially preferably between −10° C. and 20° C. or between 50 and 120° C. At temperatures of over 120° C., it is preferable to operate under a pressure of at least 1500 hPa.

The reaction time in step a) is, for example, 10 seconds to 24 hours, preferably 5 minutes to 10 hours.

When a gas comprising phosphorus pentafluoride and hydrogen chloride is used, the gas leaving the reaction vessel is collected in an aqueous solution of alkali metal hydroxide, preferably an aqueous solution of potassium hydroxide, especially preferably in a 5 to 30% by weight, very especially preferably in a 10 to 20% by weight, particularly preferably in a 15% by weight solution of potassium hydroxide in water.

Preferably, the gas or gas mixture used in step a) is prepared in the gas phase. The reactors to be used for this purpose, preferably tubular reactors, especially stainless steel tubes, and also the reaction vessels to be used for the synthesis of lithium hexafluorophosphate, are known to those skilled in the art and are described, for example, in Lehrbuch der Technischen Chemie—Band 1, Chemlsche Reaktionstechnik [Handbook of Industrial Chemistry—Volume 1, Chemical Engineering], M. Baems, H. Hofmann, A. Renken, Georg Thieme Verlag Stuttgart (1987), pp. 249-256.

The contacting in step a) can be carried out, for example, by introducing the gas comprising phosphorus pentafluoride and hydrogen chloride into the suspension.

In an alternative embodiment, the gas comprising phosphorus pentafluoride and hydrogen chloride is passed over the suspension comprising lithium fluoride and a first organic solvent.

The contacting temperature in step a) may be, for example, from the freezing point to the boiling point of the aqueous medium used, preferably 0 to 100° C., especially preferably 10 to 60-C and especially preferably 10 to 35° C., particularly 16 to 24° C.

The contacting pressure in step a) may, for example, be 100 hPa to 2 MPa, 900 hPa to 1200 hPa, especially ambient pressure is particularly preferred.

The contacting in step a) may be carried out, for example, continuously or batchwise in any reaction vessel known to those skilled in the art for the reaction of liquids with gases, which is preferably resistant to hydrogen fluoride such as those composed of Teflon.

In an alternative embodiment, the resulting reaction mixture is stirred, for example, during the contacting, alternatively during and after the contacting or also alternatively after the contacting of the gas comprising phosphorus pentafluoride and hydrogen chloride with lithium fluoride in a first organic solvent. The contacting may be facilitated by introducing mixing energy, for example, by static or non-static mixing elements.

The reaction mixture prepared, comprising lithium hexafluorophosphate, a first organic solvent and hydrogen chloride, is stirred, for example, for a duration of 10 seconds to 24 hours, preferably 5 minutes to 12 hours, particularly preferably 10 minutes to 4 hours and very especially preferably 30 minutes to 2 hours and is subsequently filtered preferably through a filter having a pore size of 50 nm.

The further organic solvent according to the invention is characterized in that, in the further organic solvent, lithium hexafluorophosphate a lower solubility than in the first organic solvent.

It is clear to those skilled in the art that the solution behavior depends on the temperature, if the temperature selected for step b) is to meet the abovementioned requirement.

The contacting temperature may be, by way of example and preferably, from the freezing point up to the boiling point of the organic solvent used or its lowest boiling component, for example, from −45 to 80° C., especially preferably from 10 to 60° C. and especially preferably from 10 to 35° C., particularly from 16 to 24° C.

The contacting pressure may, for example, be from 100 hPa to 2 MPa, preferably from 900 hPa to 1200 hPa, ambient pressure is particularly preferred.

Preference is given to toluene as the further organic solvent.

The solubility of lithium hexafluorophosphate in the first organic solvent and in the further organic solvent can be determined as such by a few preliminary experiments.

The first organic solvent according to the invention and the further organic solvent, before utilization thereof, are preferably subjected to a drying process, especially preferably to a drying process over a molecular sieve.

The content of impurities, particularly water, of the first organic solvent according to the invention and the further organic solvent should be as low as possible. In one embodiment, it is from 0 to 500 ppm, preferably from 0 to 200 ppm, particularly preferably from 0 to 100 ppm and especially preferably 1 ppm or less.

The further organic solvent is brought into contact with the reaction mixture from step a) in such a way, for example, that the reaction mixture comprising lithium hexafluorophosphate, a first organic solvent and hydrogen chloride is metered into the initially charged further organic solvent.

Likewise, any other sequence of bringing the further organic solvent in contact with the reaction mixture from step a) is generally suitable.

In an alternative embodiment, the contacting is carried out, for example, in such a way that the reaction mixture from step a) is initially charged and the further organic solvent is metered in.

The contacting of the further organic solvent with the reaction mixture from step a) can be carried out, for example, continuously, by introducing the further organic solvent for example, or batchwise, for example, by adding portions, preferably by dropwise addition. For the contacting, any container known to those skilled in the art for contacting solutions are suitable. The contacting may be facilitated by introducing mixing energy, for example, by static or non-static mixing elements.

The temperature in step b) may be, by way of example and preferably, from the freezing point up to the boiling point of the organic solvent used or its lowest boiling component, for example, from −45 to 80° C., especially preferably from 10 to 60° C. and especially preferably from 10 to 35° C., particularly from 16 to 24° C.

The contacting pressure in step b) may, for example, be from 100 hPa to 2 MPa, preferably from 900 hPa to 1200 hPa, ambient pressure is particularly preferred.

The further organic solvent is preferably brought into contact with the reaction mixture from step a) over a time period of one second to 48 hours, preferably 10 seconds to 2 hours, particularly preferably 30 seconds to 45 minutes and especially preferably 1 minute to 30 minutes.

In an alternative embodiment, mixing can take place after step b) by introducing mixing energy, for example, by static or non-static mixing elements.

In an alternative embodiment, the mixture comprising lithium hexafluorophosphate, a first organic solvent and a further organic solvent, Is stirred, for example, for a duration of 10 seconds to 24 hours, preferably 1 minute to 12 hours, particularly preferably 5 minutes to 2 hours and very especially preferably 10 minutes to 1 hour.

The contacting in step b) leads to a precipitation of the lithium hexafluorophosphate.

In a further embodiment, a further contacting with further organic solvent or other organic solvents can be carried out after step b). This has the purpose that, in addition to the drying, a further solvent exchange also takes place.

The precipitated lithium hexafluorophosphate can be separated by any method for separating solids and liquids known to those sidled in the art. The separation can be effected, for example, by sedimentation, centrifugation or filtration, for example by pressure filtration or suction filtration. The separation can be effected, for example, by using a paper filter, polymer filter, a glass frit or a ceramic frit, preferably by a Teflon filter, particularly by a filter of a defined pore size, for example, a filter of a pore size of <5 μm, preferably <1 μm, particularly preferably <200 nm.

In an alternative embodiment, for example, the separated, solid lithium hexafluorophosphate can be dried under inert gas, preferably argon.

In an alternative embodiment, if the separation is partial, the establishment of a specific content of lithium hexafluorophosphate is possible. If the separation is very substantially complete, it is possible to obtain high-purity lithium hexafluorophosphate in solid form. Very substantially complete means here that the remaining content of organic solvent is 5000 ppm or less, preferably 2000 ppm or less.

In an alternative embodiment, the lithium hexafluorophosphate prepared according to the invention is dissolved, for example, in a first organic solvent. The dissolution is effected, for example, at a temperature of −45° C. to room temperature, preferably at a temperature of −10 to 10° C. and especially preferably at a temperature of −5 to 5° C. This solution is brought into contact with further organic solvent. This may be effected, for example, in that the solution of lithium hexafluorophosphate is charged in a first organic solvent, and further organic solvent is added. In an alternative embodiment, the further organic solvent can be charged and the solution of lithium hexafluorophosphate in a first organic solvent is added. In this case, as already described previously, lithium hexafluorophosphate precipitates out as a solid. Using the separation methods described above, the precipitated solid is separated from the first organic solvent and the further organic solvent Preference is given to using a reversible Teflon frit for the separation of the solid lithium hexafluorophosphate.

This method, referred to as recrystallization, can be repeated any number of times, preferably one to three times.

In an alternative embodiment, the solid lithium hexafluorophosphate may be washed with organic solvent, preferably the further organic solvent described above.

Surprisingly, the reaction product lithium hexafluorophosphate comprises only low amounts of chloride after completion of step c), despite the high concentrations of hydrogen chloride in step a). Without wishing to be scientific in any way, the applicant speculates that the chlorides remain in the first organic solvent. Lithium hexafluorophosphate is poorly soluble in the further organic solvent and therefore precipitates out.

Lithium hexafluorophosphate prepared according to the invention typically has a content of impurities of 0 to 10 000 ppm, preferably 0 to 5000 ppm, particularly preferably 0 to 1000 and very especially preferably 0 to 100 ppm.

Typical Impurities include, for example, hydrolytic degradation products, in particular lithium difluorophosphate, acids, and also metal cations, particularly calcium, chromium, iron, magnesium, molybdenum, cobalt, nickel, cadmium, lead, potassium or sodium and extraneous anions, particularly sulfate, hydroxide, hydrogen carbonate and carbonate.

In an alternative embodiment, impurities, for example, acids, can be brought into contact and neutralised by addition of basic substances, for example, a base selected from the group consisting of alkaline earth metal hydroxides, alkaline earth metal hydrogen carbonates, alkaline earth metal carbonates, lithium hydroxide, lithium hydrogen carbonate and lithium carbonate.

Lithium hexafluorophosphate prepared according to the invention typically has a chloride content of 0 to 100 ppm, preferably 0 to 50 ppm, particularly preferably 0 to 5 ppm and very especially preferably 0 to 1 ppm.

The chloride content is determined as stated in the examples.

Due to the low chloride content, the lithium hexafluorophosphate prepared according to the invention can be processed, for example, to give electrolytes suitable for electrochemical storage devices.

The invention also relates to the use of lithium hexafluorophosphate prepared according to the invention as, or for preparing, electrolytes for lithium accumulators.

Electrolytes can be prepared by general methods known per se by bringing lithium hexafluorophosphate into contact with organic solvent and optionally additives.

The invention further relates to a method for preparing electrolytes for lithium accumulators, characterized in that the lithium hexafluorophosphate used comprises by a method comprising at least steps a) to c) and optionally d) of the method according to the invention.

The electrolytes prepared by the method according to the invention may comprise further conductive salts such as lithium fluorosulfonylimide.

The particular advantage of the invention lies in the efficient procedure and in the low amounts of chloride in the lithium hexafluorophosphate prepared in accordance with the invention.

### EXAMPLES

In the following, the symbol “%” and “ppm” are always understood to mean % by weight and “ppm by weight” respectively.

“Inert gas condition” or inert gas signifies that the water and the oxygen content of the atmosphere is below 1 ppm.

### Determination of the Chloride and Hexafluorophosphate Content:

In relation to the ion chromatography used in the context of the present work, refer to the publication L Terborg, S. Nowak, S. Passerini, M. Winter, U. Karst, P. R. Haddad, P. N. Nesterenko, Ion chromatographic determination of hydrolysis products of hexafluorophosphate salts in aqueous solution. Analytica Chimica Acta 714 (2012) 121-126 and refer to the literature cited therein.

The analysis of chloride and hexafluorophosphate Ions present was carried out by ion chromatography. For this purpose, the following instruments and settings are used:
Instrument type: Dionex ICS 2100
Column: IonPac® AS20 2*250-mm “Analytical Column with guard”
Sample volume: 1 μl
Mobile phase: KOH gradient: 0 min/15 mM, 10 min/15 mM, 13 min/80 mM, 27 min/100 mM, 27.1 min/15 mM, 34 min/15 mM
Mobile phase flow rate: 0.25 ml/min
Temperature: 30° C.
Self-Regenerating Suppressor: ASRS® 300 (2-mm)

The limit of detection for chloride ions is 1 ppm.

### Determination of Total Acid as Hydrogen Fluoride:

In relation to the determination of the total acid applied in the context of the present work, see the publication M. Schmidt, U. Heider, A. Kushner, R. Oesten, M. Jungnitz, N. Ignat'ev, P. Sartori, Lithium fluoroalkylphosphates: a new class of conducting salts for electrolytes for high energy lithium-ion batteries. Journal of Power Sources 97-98 (2001) 557-560 and refer to the literature cited therein. To determine the total acid, 1.79 g of the solid electrolyte were dissolved with cooling in 13.21 g of a mixture of ethylene carbonate and dimethyl carbonate (weight ratio 1:1). Part of the solution was titrated to determine the total acid according to the literature cited above. In a glass vessel under inert conditions, 0.2 ml of indicator solution (50 mg bromothymol blue in 50 ml of anhydrous isopropanol) were titrated with a 0.01N tetrabutylammonium hydroxide solution (in anhydrous isopropanol) up to the point of color change to blue-green. Subsequently, ca. 1000 mg of electrolyte solution were weighed out to an accuracy of 0.1 mg. The latter was titrated with 0.01N tetrabutylammonium hydroxide solution once again up to the blue-green color change, and the consumption of tetrabutylammonium hydroxide solution was weighed to an accuracy of 0.1 mg.

### Determination of the Water Content:

Water contents were determined, unless stated otherwise, by the Karl Fischer method, which is known to those skilled in the art and is described, for example, in P. Bruttel, R. Schlink, “Wasserbestimmung durch Karl-Fischer-Titration”, [Water determination by Karl Fischer titration] Metrohm Monograph 8.026.5001, 2003-06.

### Photometric Determination of Metal Contents (Iron, Nickel, Lead, Cadmium):

Metal contents were determined by means of a photometric rapid test from Merck (Spectroquant® cuvette test). The photometer used was a Spectroquant Pharo 100 M (Merck).

The limit of detection for iron is 1.3 ppm.

The limit of detection for nickel is 2.6 ppm.

The limit of detection for lead is 2.6 ppm.

The limit of detection for cadmium is 0.6 ppm.

### Phosphorus Pentafluoride:

Examples 1 to 4 were carried out using commercially available phosphorus pentafluoride (99%; abcr GmbH, CAS 7647-19-0).

The phosphorus pentafluoride for examples 5 and 6 was prepared as follows:

Stage 1: PCl₃+3 HF→PF₃+3 HCl
Reaction of phosphorus trichloride with hydrogen fluoride to give phosphorus trifluoride and hydrogen chloride
   Stage 2: PF₃+Cl₂→PCl₂F₃
Reaction of phosphorus trifluoride with elemental chlorine to give phosphorus dichloride trifluoride
   Stage 3: PCl₂F₃+2 HF→PF₅+2 HCl
Reaction of phosphorus dichloride trifluoride with hydrogen fluoride to give phosphorus pentafluoride and hydrogen chloride.
   Sum total: PCl₃+5 HF+Cl₂→PF₅+5 HCl
   Experimental preparation of PF₅:

A mixture of 20 g/h of hydrogen fluoride and 11.4 ml/h of phosphorus trichloride (both in gaseous form) was passed through a reactor tube of length ca. 6 m which had been heated to 280° C. This reaction mixture was cooled to room temperature, 6.5 l/h of chlorine was introduced and the mixture was passed through a further ca. 6 m long reactor tube at room temperature.

### General Preparation Conditions:

Unless otherwise stated, all procedures were carried out under argon protective gas. Acetonitrile (Fluka, Trace Select ≧99.9%), toluene (Azelis, technical grade, dried over P₂O₅ and distilled) and lithium fluoride (Sigma-Aldrich, 99.995%) were obtained from Sigma-Aldrich. The water content of the organic solvent used was below 50 ppm. Some procedures are carried out in a glove box (Mbraun unilab), wherein the oxygen and water content in the atmosphere was below 0.1 ppm.

### Example 1

### Preparation of Lithium Hexafluorophosphate in Acetonitrile (Saturated)

250 ml of acetonitrile and 25.61 g of lithium fluoride were charged at room temperature in a 500 ml Teflon apparatus filled with argon. Into the resulting suspension were firstly Introduced 180 g of hydrogen chloride gas and subsequently 186.58 g of gaseous phosphorus pentafluoride. The reaction mixture obtained was stirred for one hour. The reaction mixture was filtered and the solid obtained was blown dry in an argon stream. This gave 153 g of solid (44% yield).

| | |
|---|---|
| Characterization of the solid: | |
| Chloride content: | Below the limit of detection |
| Lithium hexafluorophosphate: | 42.7% by weight |

### Example 2

### Preparation of Lithium Hexafluorophosphate in Acetonitrile and Subsequent Precipitation with Toluene

250 ml of acetonitrile and 6.49 g of lithium fluoride were charged at room temperature in a 500 ml Teflon apparatus filled with argon. Into the resulting suspension were firstly introduced 27.35 g of hydrogen chloride gas (chloride content of the suspension after Introduction: 12.1% by weight) and subsequently 47.24 g of gaseous phosphorus pentafluoride. The reaction mixture obtained was stirred for one hour. The reaction mixture was metered into 500 ml of toluene. The precipitated solid was filtered off and blown dry in an argon stream. This gave 34.7 g of solid (91% yield).

| | |
|---|---|
| Characterization of the solid: | |
| Chloride content: | Below the limit of detection |
| Lithium hexafluorophosphate: | 68.5% by weight |

### Example 3

### Preparation of Lithium Hexafluorophosphate in Acetonitrile and Subsequent Precipitation with Toluene

250 ml of acetonitrile and 6.49 g of lithium fluoride were charged at room temperature in a 500 ml Teflon apparatus filled with argon. Into the resulting suspension were firstly introduced 27.35 g of hydrogen chloride gas (chloride content of the suspension after introduction: 12.1% by weight) and subsequently 47.24 g of gaseous phosphorus pentafluoride. The reaction mixture obtained was stirred for one hour. The reaction mixture was metered into 1000 ml of toluene and stirred for 15 minutes. The precipitated solid was filtered off and blown dry in an argon stream. This gave 29.1 g of solid (77% yield).

| | |
|---|---|
| Characterization of the solid: | |
| Chloride content: | Below the limit of detection |
| Lithium hexafluorophosphate: | 99.0% by weight |

### Example 4

### Preparation of Lithium Hexafluorophosphate in Acetonitrile and Subsequent Precipitation with Toluene and Recrystallization

250 ml of acetonitrile and 6.49 g of lithium fluoride were charged at room temperature in a 500 ml Teflon apparatus filled with argon. Into the resulting suspension were firstly introduced 27.35 g of hydrogen chloride gas (chloride content of the suspension after introduction: 12.1%) and subsequently 47.24 g of gaseous phosphorus pentafluoride. The reaction mixture obtained was stirred for one hour. The reaction mixture was metered into 500 ml of toluene and stirred for 15 minutes. The precipitated solid was filtered off and blown dry in an argon stream. This gave 29.5 g of solid (79% yield).

| | |
|---|---|
| Characterization of the soild: | |
| Chloride content: | Below the limit of detection |
| Lithiumhexafluorophosphate: | 97.9% by weight |

### Recrystallization:

in the glove box, 20 g of the solid obtained were dissolved in 88 g of acetonitrile at 0° C. The resulting solution was added to 352 g of toluene. The precipitated solid was immediately filtered through a reversible Teflon frit, washed with 50 ml of toluene and dried by blowing with argon. This gave 14.75 g of solid.

| | |
|---|---|
| Characterization of the solid: | |
| Chloride content: | Below the limit of detection |
| Lithium hexafluorophoshate: | 98.0% by weight |

### Example 5

### Preparation of Lithium Hexafluorophosphate in Acetonitrile and Subsequent

Precipitation with Toluene and Recrystallization 250 ml of acetonitrile and 6.49 g of lithium fluoride were charged at room temperature in a 500 ml Teflon apparatus filled with argon without upstream cold trap. Into the resulting suspension was introduced the gaseous phosphorus pentafluoride/hydrogen chloride mixture (PF₅/HCl) prepared according to the generation method mentioned above, until nominally 1 equivalent of phosphorus pentafluoride (calculated from the consumption of PCl₃; 20 ml consumption) was present. The reaction mixture obtained was stirred for one hour. The reaction mixture was metered into 500 ml of toluene and stirred for 15 minutes. The precipitated solid was filtered off and blown dry in an argon stream. This gave 30.3 g of solid (79% yield).

| | |
|---|---|
| Characterization of the solid: | |
| Chloride content: | 28 ppm |
| Lithium hexafluorophosphate: | 99.0% by weight |

A solution (11.8% by weight lithium hexafluorophosphate) in dimethyl carbonate/ethylene carbonate (DMC/EC) was prepared from the solid.

| | |
|---|---|
| Characterization of the solution: | |
| Total acid: | 19.1 ppm |
| Iron: | Below the limit of detection of 1.3 ppm |
| Nickel: | Below the limit of detection of 2.6 ppm |
| Lead: | Below the limit of detection of 2.6 ppm |
| Cadmium: | Below the limit of detection of 0.6 ppm |
| Water content: | 1.1 ppm |

### Recrystallization:

In the glove box, 15 g of the solid obtained were dissolved in 66 g of acetonitrile at 0° C. The resulting solution was added to 264 g of toluene. The precipitated solid was immediately filtered through a reversible Teflon frit, washed with 50 g of toluene and blown dry in an argon stream. This gave 17.15 g of solid.

| | |
|---|---|
| Characterization of the solid: | |
| Chloride content: | Below the limit of detection |
| Lithium hexafluorophosohate: | 80.0% by weight |

### Example 6

### Preparation of Lithium Hexafluorophosphate in Acetonitrile and Subsequent Precipitation with Toluene and Recrystallization

250 ml of acetonitrile and 6.49 g of lithium fluoride were charged at room temperature in a 500 ml Teflon apparatus filled with argon with upstream cold trap. Into the resulting suspension was introduced the gaseous phosphorus pentafluoride/hydrogen chloride mixture (PF₅HCl) prepared according to the generation method mentioned above, until nominally 1 equivalent of phosphorus pentafluoride (calculated from the consumption of PCl₃; 20 ml consumption) was present. The reaction mixture obtained was stirred for one hour. The reaction mixture was metered into 500 ml of toluene and stirred for 15 minutes and left to stand overnight. The precipitated solid was filtered off and blown dry in an argon stream. This gave 48.0 g of solid (71% yield).

| | |
|---|---|
| Characterization of the solid: | |
| Chloride content: | Below the limit of detection |
| Lithium hexafluorophosphate: | 56.3% by weight |

### Recrystallization:

In the glove box, 40 g of the solid obtained were dissolved in 176 g of acetonitrile at 0° C. The resulting solution was added to 704 g of toluene. The precipitated solid was immediately through a reversible Teflon frit, washed with 50 g of toluene and blown dry in an argon stream. This gave 16.9 g of solid.

| | |
|---|---|
| Characterization of the solid: | |
| Chloride content: | Below the limit of detection |
| Lithium hexafluorophosphate: | 99.0 Gew.-% |

1. A method for preparing crystal lithium hexafluorophosphate having a low-chloride content, the process comprising:
contacting lithium fluoride in a first organic solvent comprising a nitrile with a gas comprising phosphorus pentafluoride and hydrogen chloride produce a reaction mixture comprising lithium hexafluorophosphate, a first organic solvent comprising a nitrile and hydrogen chloride,
contacting the reaction mixture with a further organic solvent, which is different from the first organic solvent, to crystallize lithium hexafluorophosphate, and
separating the crystallized lithium hexafluorophosphate.

2. The method as claimed in claim 1, wherein the lithium fluoride has a purity level of 98.0000 to 99.9999% by weight based on anhydrous product.

3. The method as claimed in claim 1, wherein the first organic solvent comprises a nitrile, a combination of nitriles or a combination of at least one nitrile with at least one organic solvent which is not a nitrile.

4. The method as claimed in claim 1, further comprising contacting the lithium fluoride and the first organic solvent under inert gas to obtain the lithium fluoride in a first organic solvent.

5. The method as claimed in claim 1, further comprising by a method comprising:
reacting phosphorus trichloride with hydrogen fluoride to give phosphorus trifluoride and hydrogen chloride,
reacting the phosphorus trifluoride with elemental chlorine to give phosphorus dichloride trifluoride, and
reacting the phosphorus dichloride trifluoride with hydrogen fluoride to give the gas comprising phosphorus pentafluoride and hydrogen chloride.

6. The method as claimed in claim 1, wherein the gas is a gas mixture comprising 5 to 41% by weight of phosphorus pentafluoride, 6 to 59% by weight of hydrogen chloride and 0 to 50% by weight of hydrogen fluoride, where the proportion of phosphorus pentafluoride, hydrogen chloride and hydrogen fluoride is 11 to 100% by weight.

7. The method as claimed in claim 1, wherein contacting the lithium fluoride in a first organic solvent with the gas is done at a contacting temperature from the freezing point to the boiling point of the first organic solvent.

8. The method as claimed in claim 1, wherein the lithium hexafluorophosphate has a solubility in each of the first organic solvent and the further organic solvent, and the process comprises selecting the further organic solvent such that the lithium hexafluorophosphate has a lower solubility in the further organic solvent than in the first organic solvent.

9. The method as claimed in any of claim 1, wherein the further organic solvent is toluene.

10. The method as claimed in claim 1, wherein contacting the reaction mixture with the further organic solvent comprises metering the reaction mixture into the further organic solvent.

11. The method as claimed in claim 1, further comprising recrystallization the crystallized lithium hexafluorophosphate by a process comprising,
dissolving the crystallized lithium hexafluorophosphate in a third organic solvent at a temperature of −45° C. to room temperature to produce a lithium hexafluorophosphate solution,
contacting the lithium hexafluorophosphate solution with a fourth organic solvent, to re-crystallize the lithium hexafluorophosphate,
separating the re-crystallized lithium hexafluorophosphate, and optionally repeating the re-crystallizing one to three times.

12. The method as claimed in claim 1, wherein the crystallized lithium hexafluorophosphate has a chloride content of 0 to 100 ppm.

13. A lithium hexafluorophosphate having a chloride content of 0 to 28 ppm.

14. A method for producing electrolytes for lithium accumulators, the method comprising:
contacting lithium fluoride in a first organic solvent comprising a nitrile with a gas comprising phosphorus pentafluoride and hydrogen chloride to produce a reaction mixture comprising lithium hexafluorophosphate, a first organic solvent comprising a nitrile and hydrogen chloride,
contacting the reaction mixture with a further organic solvent, which is different from the first organic solvent, to crystallize lithium hexafluorophosphate,
separating the crystallized lithium hexafluorophosphate, and
re-dissolving the crystallized lithium hexafluorophosphate in an additional solvent to produce electrolytes.

15. (canceled)

16. The method according to claim 1, wherein the first organic solvent is acetonitrile, and the further organic solvent is toluene.

17. The method as claimed in claim 1, wherein:
the first organic solvent is a nitrile, a combination of nitriles or a combination of at least one nitrile with at least one organic solvent which is not a nitrile;
the gas is a gas mixture comprising 20 to 41% by weight of phosphorus pentafluoride, 40 to 59% by weight of hydrogen chloride and 0 to 40% by weight of hydrogen fluoride, where the proportion of phosphorus pentafluoride, hydrogen chloride and hydrogen fluoride is 90 to 100% by weight;
the lithium hexafluorophosphate has a solubility in each of the first organic solvent and the further organic solvent, and the process comprises selecting the further organic solvent such that the lithium hexafluorophosphate has a lower solubility in the further organic solvent than in the first organic solvent; and
the method further comprises re-crystallizing the crystallized lithium hexafluorophosphate by a process comprising:
dissolving the crystallized lithium hexafluorophosphate in a third organic solvent at a temperature of 10 to 10° C. to produce a lithium hexafluorophosphate solution,
contacting the lithium hexafluorophosphate solution with a fourth organic solvent, to re-crystallize the lithium hexafluorophosphate, and
separating the re-crystallized lithium hexafluorophosphate,
wherein the crystallized lithium hexafluorophosphate has a chloride content of 0 to 50 ppm.

18. The method as claimed in claim 17, wherein:
the lithium fluoride has a purity level of 99.9000 to 99.9995% by weight, based on anhydrous product;
contacting the lithium fluoride in a first organic solvent with the gas is done at a first temperature of 10 to 60° C. and a first pressure of 100 hPa to 2 MPa;
contacting the reaction mixture with the further organic solvent is done at a second temperature of 10 to 60° C. and a second pressure of 100 hPa to 2 MPa, and comprises metering the reaction mixture into the further organic solvent; and
the method further comprises:
preparing the gas by a method comprising:
reacting phosphorus trichloride with hydrogen fluoride to give phosphorus trifluoride and hydrogen chloride,
reacting the phosphorus trifluoride with elemental chlorine to give phosphorus dichloride trifluoride, and
reacting the phosphorus dichloride trifluoride with hydrogen fluoride to give the gas comprising phosphorus pentafluoride and hydrogen chloride.

19. The method as claimed in claim 18, wherein:
the lithium fluoride has a purity level of 99.9700 to 99.9995% by weight, based on anhydrous product;
the gas mixture comprises 33 to 41% by weight of phosphorus pentafluoride, 49 to 59% by weight of hydrogen chloride and 0 to 18% by weight of hydrogen fluoride, where the proportion of phosphorus pentafluoride, hydrogen chloride and hydrogen fluoride is 95 to 100% by weight;
each of the first temperature and second temperature is 16 to 24° C. and each of the first contact pressure and the second contact pressure is 900 hPa to 1200 hPa; and
the method further comprises:
mixing during each of: contacting the lithium fluoride in a first organic solvent comprising a nitrile with the gas, and contacting the reaction mixture with the further organic solvent;
contacting the lithium fluoride and the first organic solvent under argon gas to obtain lithium fluoride in a first organic solvent; and
repeating the re-crystallizing one to three times,
wherein the crystallized lithium hexafluorophosphate has a chloride content of 0 to 1 ppm.

20. The method according to claim 19, wherein the first organic solvent is acetonitrile, and the further organic solvent is toluene.
